(19) United States
(12) Patent Application Publication
(10) Pub. No.: US 2026/0084982 A1
(43) Pub. Date: Mar. 26, 2026

(54) WATER DISPENSING DEVICE

(71) Applicant: LG ELECTRONICS INC., Seoul (KR)

(72) Inventors: Sangjoon LEE, Seoul (KR); Kowoon BAEK, Seoul (KR); Yuri CHOI, Seoul (KR); Minyoung PARK, Seoul (KR)

(21) Appl. No.: 19/112,353

(22) PCT Filed: Sep. 7, 2023
(86) PCT No.: PCT/KR2023/013397

§ 371 Date: Mar. 17, 2025

(30) Foreign Application Priority Data
Sep. 19, 2022 (KR) 10-2022-0117731

(51) Int. Cl. C02F 1/00; C02F 1/02; C02F 1/32

(52) U.S. Cl. CPC C02F 1/001; C02F 1/02; C02F 1/32; C02F 2201/005; C02F 2209/003; C02F 2209/11; C02F 2209/44; C02F 2303/04; C02F 2307/10

(57) ABSTRACT

A water dispensing device according to an embodiment disclosed herein includes: a water supply path through which raw water supplied from a water supply source flows; a filter that generates purified water by filtering the raw water supplied via the water supply path; a purified-water path through which the purified water that has passed through the filter flows; a water quality measurement unit that is connected to the purified-water path and measures the water quality of the purified water; a sterilization path, one side of which branches from the water supply path and the other side of which is connected to the filter; a sterilization module that is provided on the sterilization path and heats the water passing through the sterilization path; a water outlet port through which the purified water is discharged; a water outlet path that guides the purified water to the water outlet port; and a water outlet sterilization module that emits ultraviolet rays at the water outlet port.

### TECHNICAL FIELD

The present disclosure relates to a water dispensing device and an operating method thereof, and more particularly, to a water dispensing device including a sensor capable of discriminating a water quality, and an operating method thereof.

### BACKGROUND ART

A water dispensing device supplies water and may take out a desired amount of water at a desired temperature according to the manipulation of a user. The water dispensing device as such may be applied to various fields, but may be applied representatively to a refrigerator and a water purifier. In particular, the water dispensing device provided in the refrigerator and the water purifier is configured to have a function that enables supplying of a preset amount of water according to the manipulation of a user. Recently, for these water dispensing devices, the water dispensing devices that may supply not only purified water but also cold and hot water have been developed.

For example, a water purifier is connected to a water supply source such as a tap to receive raw water, uses a filter to remove floating matters or harmful substances contained in the raw water, and is configured to purify and take out a desired amount of water according to the manipulation of a user. A variety of water purifier products are being released that may purify water as well as heat or cool the purified water to supply cold or hot water. In addition, recently, water purifiers that are small in size and may be installed in various installation environments are being developed.

In a case where the water dispensing device is used for a long time, microorganisms or the like may be propagated in or contaminate pipes, valves, or water outlet ports. In addition, due to the elapse of the replacement cycle of a filter, floating matters or harmful substances contained in raw water may not be removed. Accordingly, it is important for the water dispensing device to accurately measure water quality, perform hygienical management, and also manage water purification quality performance.

In particular, there is a high possibility that a water outlet port area will be contaminated by floating bacteria in the indoor air. As a method to address this issue, the related art of Korean Patent Application Publication No. 10-2018-0085145 includes an ultraviolet lamp to irradiate light to the inside or outside of the water dispensing nozzle. The related art of Korean Patent Application Publication No. 10-2018-0085145 is configured to prevent internal contamination by sterilizing the water outlet port with UV according to a predetermined operation cycle, but is not configured to operate in a way that reflects the contamination level of the actual usage environment of each product, which varies depending on the indoor air quality of the usage environment, the actual usage pattern of a user, and the degree of contamination of raw water.

### DISCLOSURE

### Technical Problem

An aspect of the present disclosure is directed to providing a water dispensing device capable of managing purified water quality and supplying safe water by measuring a water quality in real time and performing sterilization operation in response thereto.

Yet another aspect of the present disclosure is directed to providing a water dispensing device capable of automatically sensing water quality abnormalities and sterilizing water to hygienically manage a path and a water outlet port.

Yet another aspect of the present disclosure is directed to providing a water dispensing device capable of appropriately responding to water quality measurement results.

Yet another aspect of the present disclosure is directed to providing a water dispensing device capable of accurately measuring the water quality of raw water and purified water.

Yet another aspect of the present disclosure is directed to providing a water dispensing device capable of improving sensing accuracy and efficiency by a water pipe configuration and a rinse operation for sensor publicization.

### Technical Solution

A water dispensing device according to an embodiment of the present disclosure includes: a water supply path through which raw water supplied from a water supply source flows; a filter that generates purified water by filtering the raw water supplied via the water supply path; a purified-water path through which the purified water that has passed through the filter flows; a water quality measurement unit that is connected to the purified-water path and measures the water quality of the purified water; a sterilization path, one side of which branches from the water supply path and the other side of which is connected to the filter; a sterilization module that is provided on the sterilization path and heats the water passing through the sterilization path; a water outlet port through which the purified water is discharged; a water outlet path that guides the purified water to the water outlet port; and a water outlet sterilization module that emits ultraviolet rays at the water outlet port.

The water dispensing device according to an embodiment of the present disclosure may further include a control unit that selectively operates the sterilization module and the water outlet sterilization module to perform a sterilization operation based on water quality data measured by the water quality measurement unit.

When the water quality data measured by the water quality measurement unit corresponds to contamination level 1, the purified water is released normally through the water outlet port, and when the water quality data measured by the water quality measurement unit corresponds to contamination level 2 or higher, which is a contamination level higher than contamination level 1, the release of water may be stopped.

The water dispensing device according to an embodiment of the present disclosure may further include: a drainage path branched from the water outlet path between the water quality measurement unit and the water outlet port through which the raw water or the purified water is drained; and a drainage pump disposed in the drainage path.

When the water quality data measured by the water quality measurement unit corresponds to contamination level 2, the drainage pump may be operated to discharge residual water into the drainage path.

When the water quality data measured by the water quality measurement unit corresponds to contamination level 2, the water outlet sterilization module may be operated.

The water dispensing device according to an embodiment of the present disclosure may further include a water outlet valve selectively supplying the raw water or the purified water to the water outlet path and the drainage path.

When the water quality data measured by the water quality measurement unit corresponds to contamination level 3, which is a contamination level higher than contamination level 2, the sterilization module may be operated.

The purified-water path and the water outlet path may be sterilized with high temperature water released from the sterilization module.

When the water quality data measured by the water quality measurement unit corresponds to contamination level 3, the water outlet sterilization module may be operated.

When the water quality data measured by the water quality measurement unit corresponds to contamination level 4, which is a contamination level higher than contamination level 3, the sterilization module and the water outlet sterilization module may operate together.

When the water outlet sterilization module operates at contamination levels 3 and 4, the water outlet sterilization module may emit ultraviolet rays for a longer period of time at contamination level 4 than at contamination level 3.

The water quality measurement unit may re-measure the water quality of the purified water after passing the purified water therethrough at least once when the measured water quality data is higher than a contamination reference value.

The water dispensing device according to an embodiment of the present disclosure may further include an output unit that displays water quality information when the measured water quality data is not higher than the contamination reference value.

The water quality measurement unit may increase a waiting time until a next water quality measurement when performing the water quality re-measurement.

The water dispensing device according to an embodiment of the present disclosure may further include a sensing path branched from the water supply path and through which the raw water flows, wherein the water quality measurement unit may measure the water quality of the purified water when the purified water enters through the purified-water path and may measure the water quality of the raw water when the raw water enters through the sensing path.

The water quality measurement unit may measure the water quality of the purified water after performing a rinse operation in which the purified water passes through at least once when measuring the water quality of the raw water.

The water dispensing device according to an embodiment of the present disclosure may further include: a switching valve for supplying the raw water to the water supply path or the sterilization path; and a sensing valve for opening and closing the sensing path.

The water quality measurement unit may include a turbidity sensor that emits light at the raw water or a portion of the purified water and senses turbidity based on a pattern of scattered light received.

The water dispensing device according to an embodiment of the present disclosure may further include: a hot water path branched from the purified-water path at one side; a hot water module provided in the hot water path to heat purified water passing through the hot water path; a cold water path branched from the purified-water path at one side; and a cold water module provided in the cold water path to cool purified water passing through the cold water path.

### Advantageous Effects

According to at least one of the embodiments of the present disclosure, purified water quality can be managed and safe water can be supplied by measuring a water quality in real time and performing sterilization operation in response thereto.

According to at least one of the embodiments of the present disclosure, water quality abnormalities can be automatically sensed and water can be sterilized to hygienically manage a path and a water outlet port.

According to at least one of the embodiments of the present disclosure, a water dispensing device capable of appropriately responding to water quality measurement results can be provided.

According to at least one of the embodiments of the present disclosure, the sensing accuracy and efficiency can be improved by a water pipe configuration and a rinse operation for sensor publicization.

Various other benefits will be described directly or implicitly in the detailed description according to the embodiments of the present disclosure to be described later.

### DESCRIPTION OF DRAWINGS

FIG. 1 is a block diagram illustrating the main configuration of a water dispensing device according to an embodiment of the present disclosure.

FIG. 2 is a conceptual diagram illustrating a water dispensing device according to an embodiment of the present disclosure.

FIGS. 3 to 5 are diagrams for reference in describing the operation of the water dispensing device of FIG. 2.

FIG. 6 is a conceptual diagram illustrating a water dispensing device according to an embodiment of the present disclosure.

FIG. 7 is a diagram for reference in describing hygiene management standards for a water dispensing device according to an embodiment of the present disclosure.

FIG. 8 is a flowchart of an operation method of a water dispensing device according to an embodiment of the present disclosure.

FIG. 9 is a diagram for reference in describing the sterilization of a water dispensing device according to an embodiment of the present disclosure.

FIG. 10 is a diagram for reference in describing the emptiness of residual water of a water dispensing device according to an embodiment of the present disclosure.

FIG. 11 is a diagram for reference in describing turbidity standards of various countries and information provision based thereon.

FIG. 12 is a flowchart of an operation method of a water dispensing device according to an embodiment of the present disclosure.

### MODE FOR DISCLOSURE

Hereinafter, the exemplary embodiments of the present disclosure are described in detail with reference to the accompanying drawings. The present disclosure may, however, be embodied in many different forms and should not be construed as being limited to the embodiments set forth herein.

In order to clearly and briefly describe the present disclosure, the parts irrelevant to the description are omitted in the drawings. The same reference numerals are used to designate the same or similar parts throughout the specification.

With respect to constituents used in the following description, the suffixes “module” and “unit” are merely given in consideration of only facilitation of description and do not have any special importance or role. Accordingly, the “module” and the “unit” may be used interchangeably.

In addition, it will be understood that, although the terms “first”, “second”, etc. may be used herein to describe various elements, these elements should not be limited by these terms. These terms are only used to distinguish one element from another element.

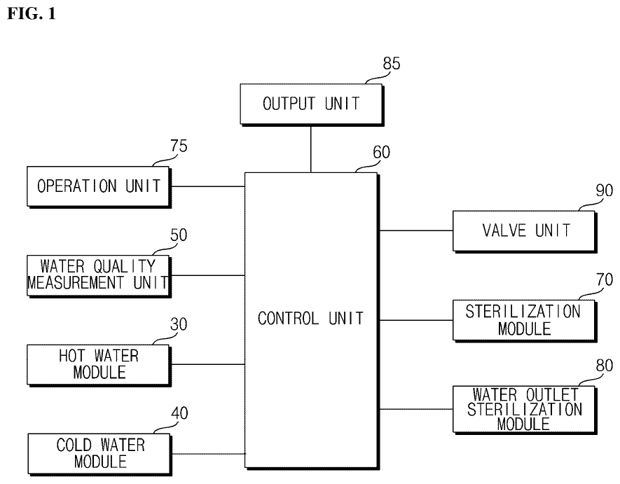

FIG. 1 is a block diagram illustrating the main configuration of a water dispensing device according to an embodiment of the present disclosure.

Referring to FIG. 1, the water dispensing device according to an embodiment of the present disclosure includes a water quality measurement unit 50. The water quality measurement unit 50 may include a turbidity sensor. According to an embodiment of the present disclosure, turbidity (contamination level) may be sensed through optical sensing. The optical sensing method for measuring turbidity uses a transmitted light method and a scattered light method. The transmitted light method senses turbidity by emitting light at a fluid, receiving light transmitted through the fluid, and processing data. The scattered light method senses turbidity by receiving scattered light and processing data, and is subdivided according to a method of generating scattered light and a method of processing the data received by light. The turbidity sensor according to an embodiment of the present disclosure may emit light at the raw water or a portion of the purified water and sense turbidity based on a pattern of scattered light received. According to an embodiment of the present disclosure, particles and microorganisms are distinguished by patterning the intensity and movement of light scattered by microorganisms, and the types of water quality/hygiene standard indicator microorganisms are distinguished by big data processing. In addition, the sensed microbial concentration values and safety indicators are provided through a display so that a user may intuitively check the same.

In addition, the water quality measurement unit 50 may utilize water quality measurement sensors such as the turbidity sensor, a microbial sensor, and a TDS sensor to sense water quality contamination of water within a path. The water quality measurement unit 50 may include at least one of the turbidity sensor, a microorganism detection sensor, a chlorine sensor, a total dissolved solids (TDS) sensor, or a BOD (biochemical oxygen demand) sensor, and may measure at least one of turbidity, microorganisms, residual chlorine, TDS, or dissolved oxygen of entering water. At least one of the sensors provided in the water quality measurement unit 50 may be a common sensor that measures the water qualities of both raw water and purified water.

In this specification, the entering of purified water or raw water in the water quality measurement unit 50 does not mean only that purified water or raw water enters inside the water quality measurement unit 50. For example, a portion of the purified water or raw water may be sampled and discharged after measuring the water quality inside the water quality measurement unit 50. In addition, at least some of the sensors provided in the water quality measurement unit 50 may measure the water quality of a flowing liquid. In this case, the entering of purified water or raw water in the water quality measurement unit 50 may mean that at least a portion of the purified water or raw water passes through the sensible section of the water quality measurement unit 50.

For example, in the case where the turbidity sensor has an internal chamber, the turbidity sensor may measure water quality by emitting light at the filled water and receiving a scattered light pattern when water enters the internal chamber connected to a path 20 and is filled. In addition, the water in the internal chamber may be discharged after measuring the water quality. Alternatively, a light source unit and a light receiving unit of the turbidity sensor may be disposed in a specific path section (for example, a section after the purified-water path 20 and a sensing path 12 are joined) to emit light at purified water or raw water passing through the specific path section and receive a scattered light pattern.

The water dispensing device according to an embodiment of the present disclosure may measure the water quality of raw water and purified water using the common sensor for the same measurement item, such as turbidity. The turbidity sensor measures the turbidity of raw water and purified water, and transmits the sensing data to a control unit 60. The control unit 60 may control other configurations of the water dispensing device based on sensing data from the water quality measurement unit 50 such as the turbidity sensor.

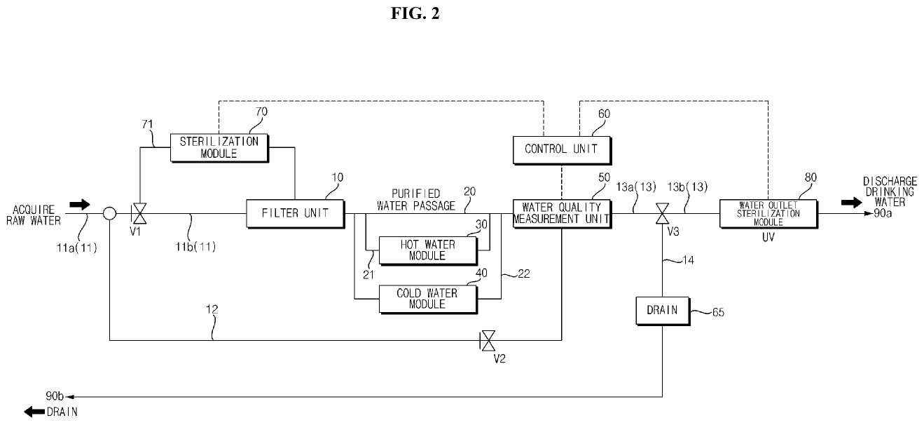

The water dispensing device includes a filter 10 (FIG. 2) that filters the raw water supplied from a water supply source to produce purified water. The filter 10 is for purification of supplied raw water and filters out various impurities and harmful substances contained in the raw water. One or more filters 10 may be provided, and in a case where a plurality of filters are provided, the filter 10 may be configured to combine filters with various functions. For example, the filter 10 may be provided in three pieces, and may include a pre-carbon filter and a post-carbon filter, and a membrane filter or a hollow fiber membrane filter disposed between the pre-carbon filter and the post-carbon filter. Alternatively, the filter 10 may be configured of a pre-carbon filter and a UF composite filter.

The purified water purified from the filter 10 flows to a storage tank or the path 20 (FIG. 2). Since water stored in the storage tank becomes a better environment for microbial growth over time, it is more desirable to flow directly through the path 20. The purified water that has passed through the filter 10 flows into the purified-water path 20.

In addition, the water dispensing device includes a valve unit 90 having valves for controlling the flow of water. The valve unit 90 may include a plurality of valves V1, V2, V3 to be described below.

When the water quality measurement unit 50 measures the water quality of the raw water, the control unit 60 may control the valve unit 90 to perform a rinse operation in which the purified water passes through the water quality measurement unit 50 at least once.

The water quality measurement unit 50 may minimize the influence of raw water on the measurement of the water quality of the purified water by measuring the water quality of the purified water after performing the rinse operation. Accordingly, a single water quality sensor of the same type may efficiently and accurately sense both raw water and purified water.

In the case of tap water and purified outlet water, the water quality contamination level is normally low. In order to measure a low-concentration contamination level, it is important to minimize the occurrence of deviation in the measurement values. According to an embodiment of the present disclosure, compared to a technology that measures raw water and outlet water separately, a path configuration and control capable of simultaneously measuring raw water and outlet water using one sensor is provided, thereby minimizing an increase in material costs and enabling a compact product configuration.

Since the tap water quality (raw water) and water purifier quality (purified water) are mostly in a low-concentration section, it is most important to minimize measurement deviation between devices by comparison with a single sensor in order to clearly express the difference in performance between raw water and outlet water.

In addition, the water dispensing device may include a hot water module 30 and a cold water module 40 for providing hot and cold water. The hot water module 30 heats purified water and then discharges the same toward a water outlet port 90a (FIG. 2). The cold water module 40 cools the purified water and then discharges the same toward the water outlet port 90a.

In addition, the water dispensing device further includes an operation unit 75 and an output unit 85.

The operation unit 75 may include one or more buttons for receiving user input. For example, the operation unit 75 may be provided with a touch panel and may include a capacity button for selecting a water outlet capacity, a hot water button for selecting hot water and further selecting the temperature of hot water to be released, a purified water button for selecting purified water, a cold water button for selecting cold water, and other function buttons.

The output unit 85 may be provided with a display device such as a display (not shown) or a light emitting diode (LED) (not shown). For example, the output unit 85 may display information such as the driving state of the water dispensing device, the operation state related to the occurrence of an error, or the contamination level of water.

The output unit 85 may be provided with an audio device such as a speaker (not shown) or a buzzer (not shown). For example, the output unit 85 may output a sound effect regarding the driving state of the water dispensing device and may output a predetermined warning sound when an error occurs.

In addition, the water dispensing device includes one or more modules for hygiene. For example, the water dispensing device includes a sterilization module 70 using high temperature water. In addition, the water dispensing device includes a water outlet sterilization module 80 for sterilizing the water outlet port 90a where contamination is highly likely to occur.

The sterilization module 70 may sterilize bacteria growing in water by instantly heating the water to a high temperature. In addition, the control unit 60 may operate the sterilization module 70 and circulate the sterilizing water (high temperature water) from the sterilization module 70 to another path to sterilize the path. The control unit 60 may control the high temperature water released from the sterilization module 70 to move to path regions based on the water quality data measured by the water quality measurement unit 50 and perform a sterilization operation for the path.

The water outlet sterilization module 80 emits ultraviolet rays toward the water outlet port 90a to remove bacteria or viruses. The water outlet sterilization module 80 may include at least one ultraviolet (UV) lamp or at least one UV light emitting diode (LED).

The water outlet sterilization module 80 may be driven periodically under the control of the control unit 60. In addition, the water outlet sterilization module 80 may be driven for a predetermined period of time before water outlet. More preferably, the control unit 60 may improve efficiency by driving the water outlet sterilization module 80 only when necessary based on water quality data measured by the water quality measurement unit 50. For example, the control unit 60 may control the water outlet sterilization module 80 based on the water quality measurement results of purified water.

The control unit 60 may be connected to each component provided in the water dispensing device. For example, the control unit 60 can transmit and/or receive signals between each component provided in the water dispensing device and control the overall operation of each component.

The control unit 60 may include at least one processor, and may control the overall operation of the water dispensing device using the processor included therein. Herein, the processor may be a general processor such as a central processing unit (CPU). The processor may be a dedicated device such as an ASIC, or may be any of other hardware-based processors.

The control unit 60 may perform various calculations based on data received through the water quality measurement unit 50 including various sensors such as the turbidity sensor 51. In addition, the control unit 60 may store data received through the water quality measurement unit 50 in a memory (not shown).

The water quality measurement unit 50 may measure water quality and output the same to the control unit 60. The control unit 60 may be controlled to perform a feedback operation in response to water quality measurement data of raw water and/or purified water. Alternatively, the water quality measurement unit 50 may directly discriminate a contamination level and transmit the same to the control unit 60, and the control unit 60 may control other components to perform appropriate feedback operations based on the received contamination level.

The control unit 60 may control the output unit 85 to recognize the contamination state of raw water and/or purified water and provide a user with information on a cleaning alarm or filter replacement cycle.

In addition, the control unit 60 may sense in advance any odor that may occur depending on the contamination level of raw water and/or purified water, and operate the automatic washing/sterilization logic through the sterilization module 70 and the water outlet sterilization module 80 before the customer feels so. Accordingly, the convenience and hygiene of use for non-professional users may be improved.

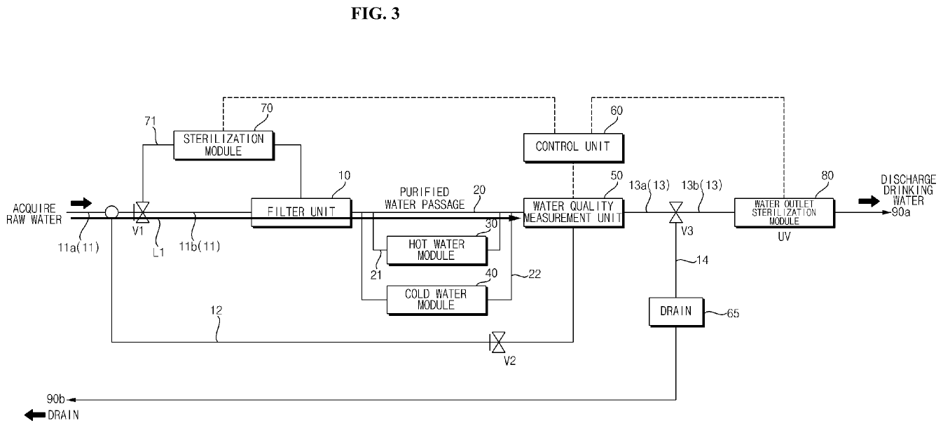

FIG. 2 is a conceptual diagram illustrating a water dispensing device according to an embodiment of the present disclosure. FIGS. 3 to 5 are diagrams for reference in describing the operation of the water dispensing device of FIG. 2.

Referring to FIG. 2, the water dispensing device includes the water supply path 11 through which raw water supplied from the water supply source flows, and the filter unit 10 that filters the raw water supplied to the water supply path 11 to produce purified water.

The purified water that has passed through the filter unit 10 flows through the purified-water path 20 toward the water outlet port 90a. The purified water that has passed through the filter unit 10 may enters the water quality measurement unit 50. The water quality measurement unit 50 may measure the water quality of purified water when the purified water enters.

In addition, the sensing path 12 is branched from the water supply path 11, so that raw water may directly enter the water quality measurement unit 50 through the sensing path 12. The water quality measurement unit 50 may measure the water quality of raw water when the raw water enters.

According to an embodiment of the present disclosure, a water supply valve V1 that controls the water supply to the filter unit 10 and the purified-water path 20 may be disposed in the water supply path 11. The water supply valve V1 may open and close the purified-water path 20. When the water supply valve V1 is opened, raw water may be purified through the filter unit 10 along a first line L1 of FIG. 3, and purified water may enter the water quality measurement unit 50 through the purified-water path 20.

The water supply path 11 may include a first water supply path 11a connecting the water supply source and the water supply valve V1, and a second water supply path 11b connecting the water supply valve V1 and the filter 10.

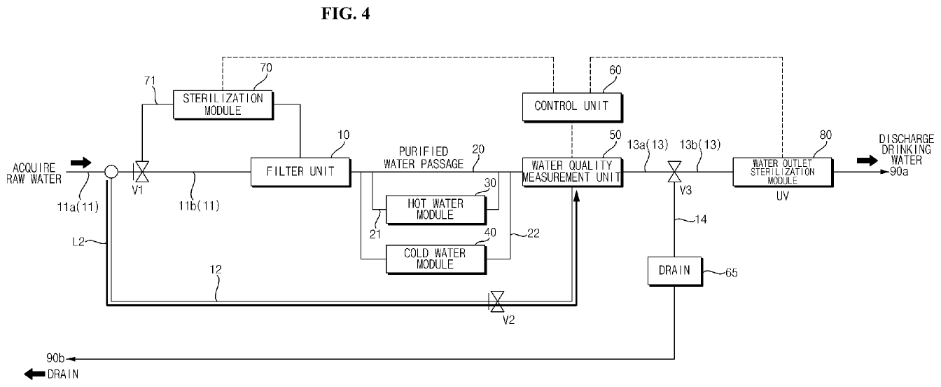

In addition, one end of the sensing path 12 may be connected to the first water supply path 11a, and the other end thereof may be connected to the water quality measurement unit 50. A sensing valve V2 that opens and closes the sensing path 12 may be disposed in the sensing path 12. When the sensing valve V2 is opened, raw water may directly enter the water quality measurement unit 50 through the sensing path 12 along a second line L2 of FIG. 4.

Referring to FIG. 2, the water dispensing device may further include: the water outlet port 90a through which the purified water is discharged; a water outlet path 13 guiding the purified water to the water outlet port 90a; a drainage path 14 branched from the water outlet path 13 between the water quality measurement unit 50 and the water outlet port 90a through which the raw water or the purified water is drained; and a water outlet valve V3 selectively supplying the raw water or the purified water to the water outlet path 13 and the drainage path 14.

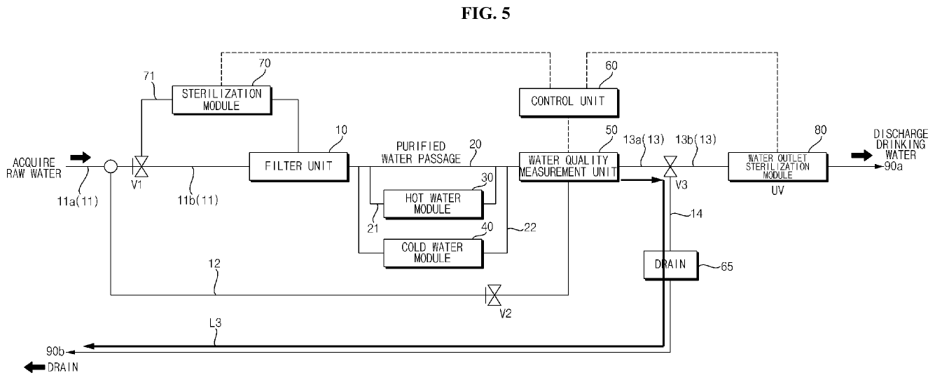

The water outlet valve V3 may, under the control of the control unit 60, divert water for which water quality measurement is completed to a drain 90b and the water outlet port 90a. When the drainage operation is performed, the water for which water quality measurement is completed is allowed to flow in the drainage path 14 along a third line L3 of FIG. 5. By draining and washing raw water, the raw water may be prevented from being released as drinking water.

The water outlet path 13 may include a first water outlet path 13a connecting the water quality measurement unit 50 and the water outlet valve V3, and a second water outlet path 13b connecting the water outlet valve V3 and the water outlet port 90a.

On the side of the water outlet port 90a through which the purified water is discharged, the water outlet sterilization module 80 that emits ultraviolet rays at the water outlet port 90a is disposed. The water outlet sterilization module 80 may sterilize a water outlet port space and residual water. The control unit 60 may operate the water outlet sterilization module 80 for a predetermined time based on the water quality data measured by the water quality measurement unit 50.

Referring to FIG. 2, a sterilization path 71 has one side branched from the water supply path 11 and the other side connected to the filter 10, and the sterilization module 70 that heats water passing through the sterilization path 71 is disposed in the sterilization path 71. The control unit 60 may operate the sterilization module 70 for a predetermined time based on the water quality data measured by the water quality measurement unit 50.

According to an embodiment of the present disclosure, the water supply valve V1 may be a switching valve that selectively supplies the raw water to the water supply path 11 or the sterilization path 71.

Referring to FIG. 2, the water dispensing device may further include: a hot water path 21 branched from the purified-water path 20 at one side; the hot water module 30 provided on the hot water path 21 to heat purified water passing through the hot water path 21; a cold water path 22 branched from the purified-water path 20 at one end side; and a cold water module 40 provided on the cold water path 22 to cool purified water passing through the cold water path 22.

Referring to FIG. 2, the hot water path 21 and the cold water path 22 may be joined again to the purified-water path 2. Alternatively, the hot water path 21 and the cold water path 22 may be joined to the water outlet path 13.

According to an embodiment of the present disclosure, a drainage pump 65 may be disposed in the drainage path 14. After measuring the water quality, when the drainage pump 65 operates, the water whose water quality has been measured may be discharged to the outside at a faster speed.

In addition, the drainage pump 65 may operate while the sterilization operation for each path region is performed. Accordingly, the high temperature water may be discharged to the outside more quickly after sterilization. In particular, when the water outlet path 13 connected to the cock on the water outlet port 90a is also sterilized, a portion of the high temperature water is discharged toward the water outlet port 90a, but a large amount of the high temperature water may be discharged toward the drain 90b. Accordingly, the occurrence of safety accidents, discomfort to users, and the inconvenience of users having to handle a large amount of hot water may be prevented as a large amount of hot water is discharged through the water outlet port 90a.

The water quality measurement unit 50 measures the water quality of the purified water when the purified water enters through the purified-water path 20, and measures the water quality of the raw water when the raw water enters through the sensing path 12.

When the water quality measurement unit 50 measures the water quality of the raw water, the water quality of the purified water may be measured after performing a rinse operation in which the purified water passes through at least once. As such, the sensing accuracy and efficiency may be improved by a water pipe configuration and a rinse operation for sensor publicization.

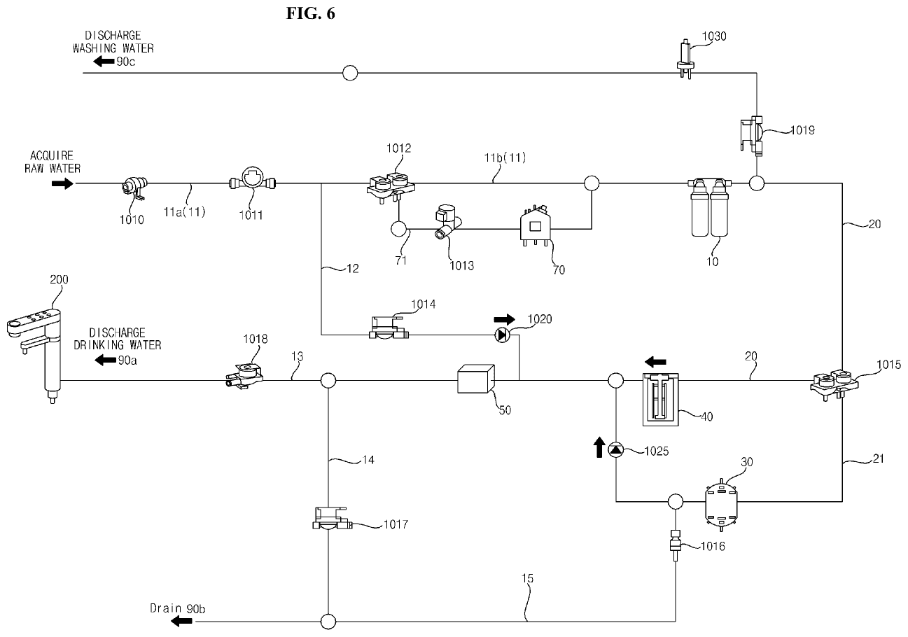

FIG. 6 is a conceptual diagram illustrating a water dispensing device according to an embodiment of the present disclosure, and illustrates a water pipe of the water dispensing device according to an embodiment of the present disclosure.

The water dispensing device according to an embodiment of the present disclosure may correspond to various water treatment apparatuses and purification apparatuses, such as water purifiers and refrigerators where water enters from the outside, purify the entered water, and then discharge the purified water.

As an example, the water dispensing device may be provided with an under sink type water purifier in which at least a portion is disposed in the lower space of a sink.

Referring to FIG. 6, the water dispensing device according to an embodiment of the present disclosure may include a water outlet unit 200 installed so that at least a portion thereof is exposed to the outside of the sink and a remaining main body unit installed on the inside of the sink.

The water dispensing device includes the water supply path 11 that guides raw water supplied from the outside to the inside, the filter 10 that purifies the raw water supplied along the water supply path 11 into purified water, and the purified-water path 20 that causes purified water passing through the filter 10 to flow toward the water outlet unit 200.

The water supply path 11 connects an external water supply source and the filter 10. Through the water supply path 11, raw water supplied from the external water supply source may be supplied to the filter 10.

As described above, water (raw water) supplied to the filter 10 is purified into purified water by passing through the filter 10. At least one of the filters 10 may be provided. For example, a plurality of filters 10 may be provided. Accordingly, water passing through the water supply path 11 may be purified into cleaner water by passing through the plurality of filters 10.

In addition, purified water passing through the filter 10 may flow through the purified-water path 20 toward the water outlet unit 200 exposed on the outside of the sink 10.

To this end, one end of the purified-water path 20 is connected to the filter 10, and the other end is connected to the water outlet unit 200. In the purified-water path 20, at least one of the cold water path 22, the hot water path 21, or a washing water path 90c may be branched.

In FIG. 6, the cold water path 22 is integrated into the purified-water path 20, and an example is illustrated in which the hot water path 21 and the washing water path 90c are branched from the purified-water path 20.

One end of the purified-water path 20 is connected to the filter 10, and water passing through the filter 10 flows toward the water outlet unit 200 through the connected water outlet path 13. The water outlet unit 200 includes the water outlet port 90a and may take out purified water.

In addition, water branched into the washing water path 90c may be supplied to a washing water outlet port in the state of sterilized water while passing through a washing water module 1030 provided on the washing water path 90c. In the case where the water outlet unit 200 includes a plurality of water outlet ports, the washing water outlet port may also be formed in the water outlet unit 200 depending on an embodiment.

A pressure reducing valve 1010 for adjusting the flow rate of water supplied to the filter 10 may be installed in the water supply path 11.

In addition, at least one of a flow sensor 1011 for sensing the flow rate of water, an inlet valve for adjusting the flow rate of water or regulating the flow of water, or a flow rate sensor (not shown) for sensing the flow rate of water may be installed in the water supply path 11 or the purified-water path 20.

In addition, separate opening/closing valves for regulating water flow in each of the purified-water path 20, the hot water path 21, and the washing water path 90c may be installed. For example, a washing water valve 1019 may be disposed in the washing water path 90c.

Alternatively, a cold/hot/purified water valve 1015 that may selectively supply purified water to the purified-water path 20 and the hot water path 21 may be installed at a diverge point of the purified-water path 20 and the hot water path 21.

In addition, a device 1025 for safety such as backflow prevention may be installed in the hot water path 21. In addition, a safety valve 1016 for steam discharge may be installed in the hot water module 30. The steam from the hot water module 30 may be drained toward the drain 90b through the connected path 15.

A water outlet valve 1018 may be disposed in the water outlet path 13 to supply or block purified water, cold water, and hot water flowing toward the water outlet unit 200 to the water outlet unit 200.

In addition, the drainage path 14 is branched from the water outlet path 13, and a drain valve 1017 is disposed in the drainage path 14 so that purified water, cold water, hot water, and raw water may be discharged toward the drain 90b.

As an example, the water outlet valve 1018 and the drain valve 1017 may be provided as a three-way valve having one inlet, a first outlet and a second outlet that are selectively opened, and an actuator that selectively opens and closes the two outlets. In this connection, the first outlet may be connected to the water outlet unit 200, and the second outlet may be connected to the drain 90b.

Raw water is supplied through the water supply path 11 connected to the water supply source such as a tap water pipe, a water tank, or an underground water pipe. The pressure reducing valve 1010 is installed in the water supply path 11, and the raw water is reduced to a set pressure while passing through the pressure reducing valve 1010.

In addition, the raw water that passes through the filter 10 becomes purified with foreign substances removed. The purified water flows along the purified-water path 20. In addition, the purified water may be branched into cold-purified water and hot water.

First, the purified water branched into the cold-purified water is branched again into cold water and purified water. Depending on the operation of the cold water module 40 corresponding to the purified water or cold water selection manipulation of a user, the purified water or cold water may be supplied to the user through the water outlet unit 200.

When a user requests the release of cold water, purified water passes through a cooling coil inside the cold water module 40. The water flowing along the cooling coil exchanges heat with the coolant inside the cold water module 40 and is cooled into cold water. To this end, the coolant is continuously cooled to maintain a set temperature. For reference, a compressor may be driven to cool the coolant. The driving of the compressor may be determined by a cold water temperature sensor provided inside the cold water module 40. Accordingly, the coolant may always maintain a set temperature, and to this end, the driving of the compressor may be adjusted. The compressor is an inverter compressor, and its frequency is adjusted in response to the required load, and its cooling capacity may be adjusted. In other words, the compressor may be driven by inverter control and cool the coolant at optimal efficiency.

When a user requests the release of hot water, the purified water may be heated to a set temperature while passing through the hot water module 30. The hot water module 30 may be heated by induction heating, and to this end, the output of the working coil included in the hot water module 30 may be adjusted. The purified water passing through the hot water module 30 may be heated to a set temperature. The heated hot water passes through the hot water module 30 and flows toward the water outlet unit 200.

The sterilization path 71 has one side branched from the water supply path 11 and the other side connected to the filter 10. In the sterilization path 71, a sterilization module 70 that heats water passing through the sterilization path 71 and a flow rate adjustment valve 1013 that controls the flow rate of the sterilization path 71 may be disposed.

At a location where the sterilization path 71 is branched from the water supply path 11, a feed valve 1012 that selectively supplies the raw water to the water supply path 11 or the sterilization path 71 may be disposed.

The water supply path 11 may include the first water supply path 11a connecting the water supply source and the feed valve 1012, and the second water supply path 11b connecting the feed valve 1012 and the filter 10.

The sensing path 12 described above may be branched in the first water supply path 11a at a front end of the feed valve 1012. A sensing valve 1014 that opens and closes the sensing path 12 and a backflow prevention device 1020 that prevents backflow of raw water may be disposed in the sensing path 12.

The control unit 60 may control the feed valve 1012 to be closed and the sensing valve 1014 to be opened so that raw water is supplied to the water quality measurement unit 50 through the sensing path 1014.

After measuring the water quality of raw water, the control unit 60 closes the water outlet valve 1018 and opens the drain valve 1017 to discharge the raw water measured by the water quality measurement unit 50 toward the drain 90b.

The control unit 60 may control the feed valve 1012 to open toward the purified-water path 20 and the sensing valve 1014 to close so that purified water is supplied to the water quality measurement unit 50.

In addition, the control unit 60 closes the water outlet valve 1018 and opens the drain valve 1017 to perform a rinse operation by controlling the purified water passing through the water quality measurement unit 50 to be discharged toward the drain 90b.

Thereafter, the control unit 60 may measure the water quality of purified water by supplying purified water to the water quality measurement unit 50 with the same valve control. Accordingly, the influence of the raw water may be removed and the water quality of the purified water may be accurately measured in the same water quality measurement unit 50.

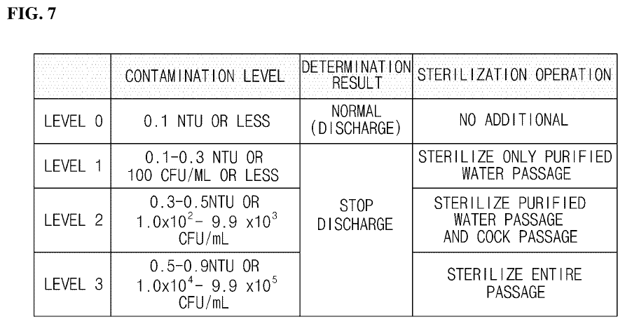

FIG. 7 is a diagram for reference in describing hygiene management standards for a water dispensing device according to an embodiment of the present disclosure. FIG. 7 is a diagram illustrating an example of hygiene management standards set according to contamination level reference values and hygiene management measures in response thereto.

Referring to FIG. 7, the control unit 60 determines that the contamination level is normal at level 1 and proceeds with the general release mode, and does not perform additional hygiene management measures.

The control unit 60 may stop the release of water when the contamination level is at levels 2 to 4 and perform an operation of hygiene management measures suitable for each contamination level.

Contamination levels may be classified into reference values decided based on drinking water quality standards in each country, including Republic of Korea. For example, based on the domestic drinking water quality standards in the Republic of Korea, 100 CFU/mL may be set as a standard to distinguish between level 1 and level 2. The standard for bacterial counts in general drinking water is 100 CFU/mL or less, and thus when the sensor measurement value is at contamination level 1, normal release of water is possible.

When the contamination level exceeds 100 CFU/mL, the contamination level is set to level 2, and the control unit 60 may be controlled to perform a residual water emptying operation to discharge residual water in a path. When the contamination level is relatively low at level 2, the occurrence of additional contamination in the filter unit 10 and the path may be reduced simply by emptying the residual water in the path.

In addition, at contamination level 2, the water outlet sterilization module 80 may operate in a basic mode. The water outlet unit 200 is an area that may come into direct or indirect contact with the outside and is therefore highly susceptible to contamination. When microbial contamination occurs at the water outlet unit 200, contamination may spread within the path. For prevention, the water outlet sterilization module 80 including a UV light source (for example, UV-C LED (278 nm)) may be used. For example, the water outlet unit UV-C LED (0.2 mW) operates in a cycle of 10 minutes On and 50 minutes Off, and may sterilize 99.99% of E. coli and S. aureus.

Generally, levels up to several hundred to several thousand CFU/mL may be determined as contamination requiring hygiene management. The water stagnates for a long time due to non-use and is affected by internal biofilm formation, the contamination level increases to 10,000 CFU/mL, and there is a risk of detection of general bacteria. Accordingly, 10,000 CFU/mL may be set as a higher contamination reference value. 10000 CFU/mL may be set as a standard of level 3.

When the contamination level exceeds 10,000 CFU/mL, the contamination level is set to level 3, and the control unit 60 may control the sterilization module 70 to operate to sterilize the path with high temperature water. Particulate contaminants such as organic matter and inorganic matter (minerals, etc.) contained in raw water always remain in the water in small quantities, and as the water dispensing device is used over time, the particulate contaminants may settle and cause contamination of the filter or internal path pipes. In this connection, hot water sterilization may be used as a way to manage internal contamination. By virtue of the washing effect of hot water sterilization at 70° C., 99.99% of attached and floating bacteria in the internal path may be sterilized.

The high temperature water generated in the sterilization module 70 flows to the purified-water path 20 and the water outlet path 13 to sterilize the purified-water path 20 and the water outlet path 13. The water outlet path 13 is a path that connects to the cock of the water outlet unit 200 and may also be called a cock path. In addition, also at level 3, the water outlet sterilization module 80 may operate in a basic mode.

In addition, when the contamination level is higher, for example, exceeding 1,000,000 CFU/mL, the contamination level is set to level 3, and the control unit 60 may operate the sterilization module 70 to sterilize the path, and the water outlet sterilization module 80 may operate in a power mode. The power mode of the water outlet sterilization module 80 may be set to have a longer ultraviolet emission time compared to the basic mode. Alternatively, the power mode may be set to have a higher UV emission intensity compared to the basic mode. Alternatively, the power mode may be set to have a longer UV emission time and a greater UV emission intensity compared to the basic mode. Alternatively, the UV emission cycle may be adjusted depending on the operating mode.

Depending on the intensity (output) of the light source of the water outlet sterilization module 80, there is a difference in the emission time that may reach 99.99% sterilization capability. For example, a 0.2 mW UV-C LED has low output and the operation cycle needs to be repeated multiple times to achieve sterilization performance. Since sterilizing power is related to UV light dose X emission time, the optimal operating time may vary depending on the LED output. According to an embodiment of the present disclosure, the operation mode may be adjusted based on the sensor measurement value of the water quality measurement unit 50. The basic UV operation mode is to turn on an LED for the minimum amount of time necessary to sufficiently sterilize at low contamination levels (for example, a cycle of 10 minutes On, 50 minutes Off). In addition, the power mode is a mode that increases sterilization power by continuously turning the LED on for xx minutes (for example, turning the LED on for 30 minutes) to quickly lower a high contamination level to level 1.

As shown in FIG. 7, as the contamination level increases, increasingly strengthened hygiene management measures may be performed. When the contamination level increases, the water outlet sterilization module 80 is operated to strengthen the hygiene management of the water outlet unit 200, and when the contamination level increases further, the sterilization module 70 may be additionally operated or the operation mode of the water outlet sterilization module 80 may be changed.

In this specification, the terms “or higher” and “exceeding” are interchangeable, and the terms “less than” and “or less” are interchangeable. For example, when the contamination level is 100 CFU/mL or higher, it may be discriminated as contamination level 2, when the contamination level is 10,000 CFU/mL or higher, it may be discriminated as contamination level 3, and when the contamination level is 1,000,000 CFU/mL or higher, it may be discriminated as contamination level 4.

Alternatively, the reference values for distinguishing contamination levels may be decided based on the drinking water turbidity water quality standards of each country, including Republic of Korea. For example, contamination levels may be distinguished based on 0.3, 0.5 and 1.0 nephelometry turbidity units (NTU).

When the contamination level is 0.3 NTU or less (less than), it may be discriminated as contamination level 1. When the contamination level exceeds 0.3 NTU (or higher) and is 0.5 NTU or less (or less than), it may be discriminated as contamination level 2. When the contamination level exceeds 0.5 NTU (or higher) and is 1.0 NTU or less (or less than), it may be discriminated as contamination level 3. When the contamination level exceeds 1.0 NTU (or higher), it may be discriminated as contamination level 4.

In another embodiment, a management measure other than the hygiene management measure exemplified in FIG. 7 may be applied.

For example, when the contamination level is level 1, the control unit 60 may control normal release of water, and when the contamination level is level 2, the control unit 60 may control to stop the release of water and perform only the operation of emptying residual water in the path. When the contamination level is relatively low at level 2, the occurrence of additional contamination in the filter unit 10 and the path may be reduced simply by emptying the residual water in the path.

In addition, when the contamination level is level 2, the control unit 60 may control the sterilization of hot water by operating the sterilization module 70. In addition, when the contamination level is level 3, the control unit 60 may control water outlet unit sterilization and path hot water sterilization by operating the sterilization module 70 and the water outlet sterilization module 80 together.

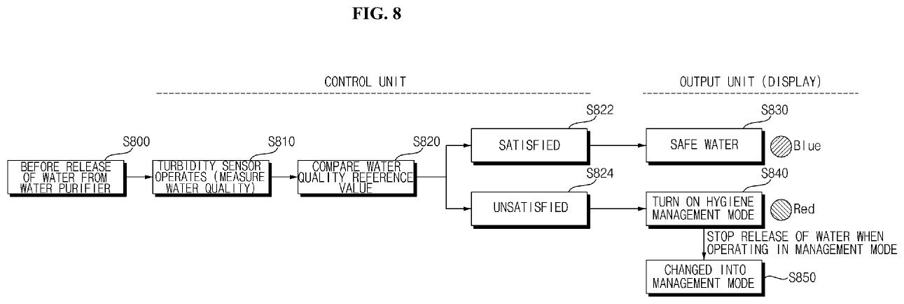

FIG. 8 is a flowchart of an operation method of a water dispensing device according to an embodiment of the present disclosure.

Referring to FIG. 8, before the release of water from the water dispensing device such as a water purifier (S800), the water quality measurement unit 50 operates to measure the water quality of purified water (S810). For example, the turbidity sensor of the water quality measurement unit 50 senses the turbidity of purified water passing through the filter 10 in real time (S810). The water quality data measured by the water quality measurement unit 50 is transmitted to the control unit 60, and the control unit 60 compares the measured water quality data with the water quality reference value (S820).

When the comparison result (S820) satisfies the water quality standard (S822), the control unit 60 may control normal release of water, and the output unit 85 may provide a user with water quality data satisfying the water quality standard as intuitive information such as safe water and blue color (S830).

When the comparison result (S820) does not satisfy the water quality standard (S824), the control unit 60 may control the entry into the hygiene management mode described with reference to FIG. 7, and the output unit 85 may provide a user with water quality data unsatisfying the water quality standard as intuitive information such as entry into the hygiene management mode and red color (S840).

When entering the hygiene management mode, the control unit 60 may control the release of water to stop depending on the contamination level and perform management measures of levels 2 to 4 (S850).

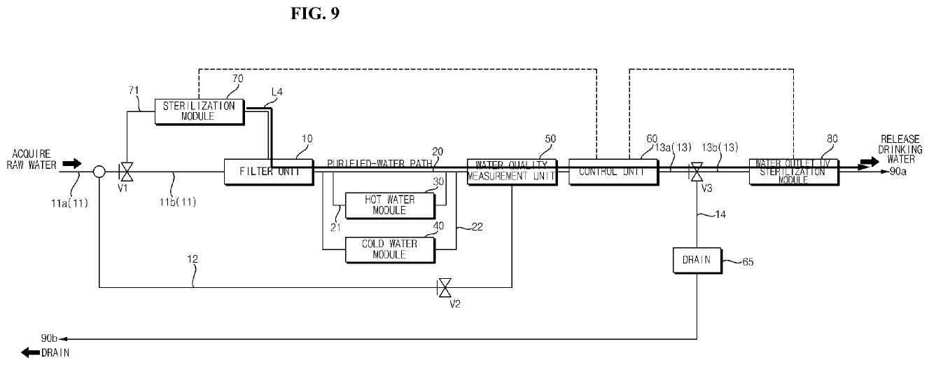

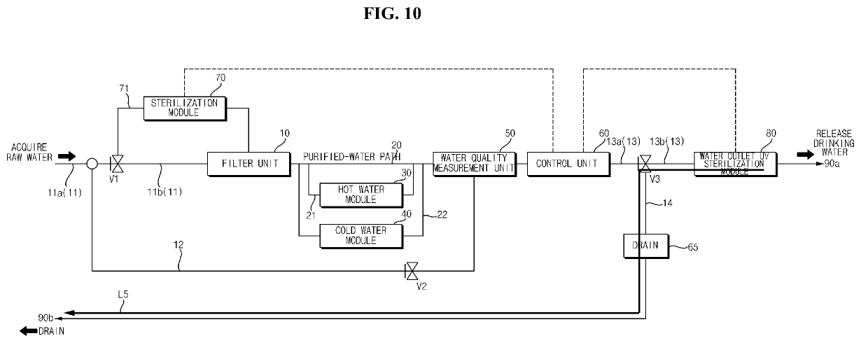

FIG. 9 is a diagram for reference in describing the sterilization of a water dispensing device according to an embodiment of the present disclosure. FIG. 10 is a diagram for reference in describing the emptiness of residual water of a water dispensing device according to an embodiment of the present disclosure.

Referring to FIGS. 9 and 10, the water dispensing device includes the water supply path 11 through which raw water supplied from the water source flows, and the filter unit 10 that filters the raw water supplied to the water supply path 11 to produce purified water.

The purified water that has passed through the filter unit 10 flows through the purified-water path 20 toward the water outlet port 90a. The purified water that has passed through the filter unit 10 may enters the water quality measurement unit 50. The water quality measurement unit 50 may measure the water quality of purified water when the purified water enters.

The sterilization path 13 may be branched from the water supply path 11. The sterilization path 13 is branched from the water supply path 11 on one side and connected to the filter unit 10 on the other side. The sterilization module 70 is disposed in the sterilization path 13 to produce high temperature water for sterilization.

The water dispensing device moves the high temperature water released from the sterilization module 70 to path regions based on the water quality data measured by the water quality measurement unit 50 and performs a sterilization operation for each path region.

Referring to FIGS. 9 and 10, the water dispensing device includes: the water outlet port 90a through which the purified water is discharged; the water outlet path 13 guiding the purified water to the water outlet port 90a; the drainage path 14 branched from the water outlet path 13 between the water quality measurement unit 50 and the water outlet port 90a through which the raw water or the purified water is drained; and the water outlet path 13 of the raw water or the purified water. In addition, at the end of the water outlet path 13, the water outlet sterilization module 80 that emits ultraviolet rays at the water outlet port 90a is disposed.

The water outlet valve V3 is disposed in the water outlet path 13 so that the raw water or purified water may be selectively supplied to the water outlet path 13b and the drainage path 14.

In the purified-water path 20, the hot water path 21 and the cold water path 22 are branched. The hot water module 30 and the cold water module 40 for heating and cooling purified water may respectively be disposed in the hot water path 21 and the cold water path 22.

The control unit 60 selectively operates the sterilization module 70 and the water outlet sterilization module 80 to perform a sterilization operation based on the water quality data measured by the water quality measurement unit 50 and according to the hygiene management mode standard.

For example, when the water quality data measured by the water quality measurement unit 50 corresponds to contamination level 1, the purified water is normally released through the water outlet port 90a, and when the water quality data corresponds to contamination level 2 or higher, which is a contamination level higher than contamination level 1, the release of water is stopped.

When the water quality data measured by the water quality measurement unit 50 corresponds to contamination level 3 or 4, a path hot water sterilization operation for sterilizing the path with high temperature water released from the sterilization module 70 may be performed. The control unit 60 may discriminate that the contamination level is level 3 or higher when the water quality data measured by the water quality measurement unit 50 is a second reference value or higher (for example, 0.5 NTU).

Referring to FIG. 9, at contamination level 3 or 4, the control unit 60 may control the purified-water path 20 and the water outlet path 13 to be sterilized with high temperature water released from the sterilization module 70. The high temperature water sterilizes the purified-water path 20 and the water outlet path 13 along a fourth line L4 and is discharged through the water outlet port 90a.

Depending on cases, a portion of the high temperature water may be set to be drained into the drainage path 14. The water outlet path 13 may include a first water outlet path 13a connecting the water quality measurement unit 50 and the water outlet valve V3, and a second water outlet path 13b connecting the water outlet valve V3 and the water outlet port 90a. The high temperature water from the sterilization module 90 flows to the purified-water path 20 and the first water outlet path 13a, and sterilizes the purified-water path 20 and the first water outlet path 13a. In addition, a portion of the high temperature water is drained to the drainage path 14, and the remaining portion thereof sterilizes the second water outlet path 13b and is discharged through the water outlet port 90a.

According to an embodiment of the present disclosure, at contamination level 3, the water outlet sterilization module 80 may operate in a basic mode, and at contamination level 4, the water outlet sterilization module 80 may operate in a power mode.

In another embodiment, at contamination level 3, only the path hot water sterilization using the sterilization module 70 may be performed, and at contamination level 4, the path hot water sterilization using the sterilization module 70 and the water outlet unit sterilization using the water outlet sterilization module 80 may be performed in combination.

According to an embodiment, when the water quality data measured by the water quality measurement unit 50 corresponds to contamination level 2, the water outlet sterilization module 80 may be operated and a residual water emptying operation may be performed.

In another embodiment, when the water quality data measured by the water quality measurement unit 50 corresponds to contamination level 2, only the residual water emptying operation may be performed.

Referring to FIG. 10, the drainage pump 65 is disposed in the drainage path 14, and depending on the operation of the drainage pump 65, residual water may be discharged through the drainage path 14. The residual water is discharged along a fifth line L5 through the drainage path 14 and into the drain 90b.

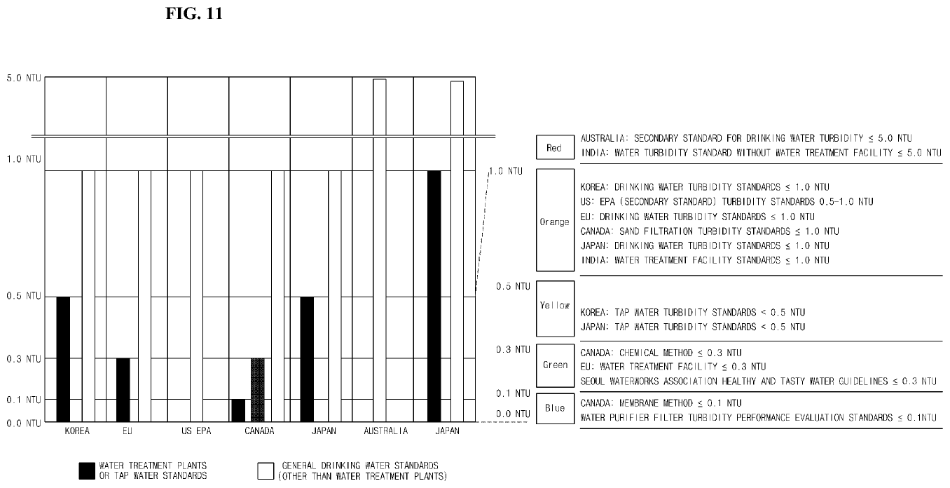

FIG. 11 is a diagram for reference in describing turbidity standards of various countries and information provision based thereon.

The reference value for distinguishing contamination levels may be set as a turbidity numerical value based on domestic and overseas legal water quality standards. Referring to FIG. 11, water treatment plants or general drinking water standards in Korea, EU, US, Canada, Japan, Australia, and India are illustrated. Based on the turbidity standards of each country, the contamination level may be distinguished and hygiene management measures may be performed according to the applicable contamination level. In addition, the output unit 85 may provide turbidity information visualized in different colors depending on the turbidity numerical value.

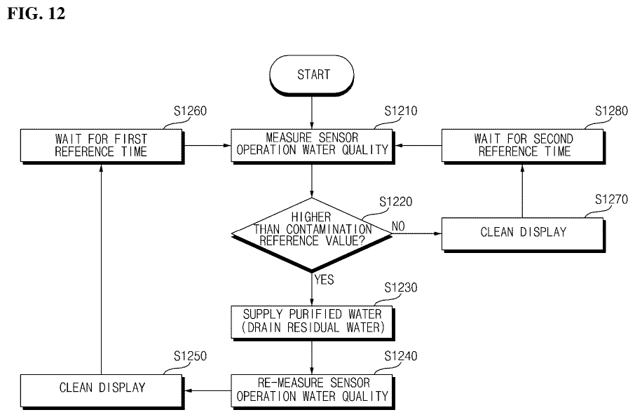

FIG. 12 is a flowchart of an operation method of a water dispensing device according to an embodiment of the present disclosure.

Referring to FIG. 12, the water quality measurement unit 50 senses the contamination level of water in real time (S1210). For example, the turbidity sensor of the water quality measurement unit 50 operates at a predetermined sensing cycle to measure water quality. During time when the water dispensing device is not in use, the water quality within the path may deteriorate due to microbial growth and biofilm formation. Accordingly, it is possible to sense the occurrence of contamination by sensing the internal water quality even during unused times.

When the measured water quality data is at a contamination reference value or higher (S1220), the control unit 60 supplies clean purified water through the water quality measurement unit 50 to the water outlet path 13 and/or the drainage path 14, and the residual water in the path may be drained through the drainage path 14 (S1230). Since purified water passes through the water quality measurement unit 50 at least once, purified water supply and residual water drainage (S1230) may correspond to the rinse operation described above. Accordingly, not only may the path be cleaned, but the sensing accuracy may also be improved.

Thereafter, the water quality measurement unit 50 may re-measure the water quality of the purified water (S1240), and the output unit 85 may display water quality information (S1250). The contaminated water is drained, the path is filled with new purified water, and a clean alarm is displayed so that users may always drink clean water.

In addition, when the measured water quality data is not higher than the contamination reference value (S1220), the output unit 85 may display water quality information (S1270).

The water quality measurement unit 50 may adjust the waiting time until the next sensing cycle (S1260, S1280) depending on whether the water quality is re-measured (S1240), in other words, whether the measured water quality data is higher than the contamination reference value (S1220).

When water quality is re-measured (S1240), the water quality measurement unit 50 waits for a first reference time (S1260) and then performs water quality measurement according to the next sensing cycle (S1210). When the water quality is measured according to the original sensing cycle (S1210), in the case where the measured water quality data is not higher than the contamination reference value (S1220), the water quality measurement unit 50 waits for a second reference time (S1280) and then performs water quality measurement according to the next sensing cycle (S1210).

Herein, the first reference time, which is applied when water quality re-measurement is performed, is longer than the second reference time, which is applied in otherwise cases. In other words, when the water quality re-measurement is performed, the waiting time until the next water quality measurement may increase.

According to an embodiment of the present disclosure, the concentration of a contamination indicator is measured after a certain period of time. When no abnormal value is sensed, additional measurements are made at shorter intervals to continuously monitor internal path and water contamination. When a contamination value is sensed, newly purified water is filled to prevent contamination of the internal path.

The water quality of the internal path, which is refilled with clean water, is re-measured through a sensor, and the water quality that is continuously maintained in a clean state is visualized in the output unit 85 so as to be provided to a user.

Hereinbefore, although preferred embodiments of the present disclosure have been illustrated and described, the present disclosure is not limited to the specific embodiments described above, and it goes without saying that persons having ordinary skills in the technical field to which the present disclosure pertains may implement the present disclosure by various modifications thereof without departing from gist of the present disclosure defined by the claims, and such modifications are not to be construed individually from the technical spirit and scope of the present disclosure.

1. A water dispensing device, comprising:
a water supply path through which raw water supplied from a water supply source flows;
a filter that generates purified water by filtering the raw water supplied via the water supply path;
a purified-water path through which the purified water that has passed through the filter flows;
a water quality measurement unit that is connected to the purified-water path and measures the water quality of the purified water;
a sterilization path, one side of which branches from the water supply path and the other side of which is connected to the filter;
a sterilization module that is provided on the sterilization path and heats the water passing through the sterilization path;
a water outlet port through which the purified water is discharged;
a water outlet path that guides the purified water to the water outlet port; and
a water outlet sterilization module that emits ultraviolet rays at the water outlet port.

2. The water dispensing device of claim 1, further comprising a control unit that selectively operates the sterilization module and the water outlet sterilization module to perform a sterilization operation based on water quality data measured by the water quality measurement unit.

3. The water dispensing device of claim 1, wherein:
when water quality data measured by the water quality measurement unit corresponds to contamination level 1, the purified water is released normally through the water outlet port; and
when the water quality data measured by the water quality measurement unit corresponds to contamination level 2 or higher, which is a contamination level higher than contamination level 1, the release of water is stopped.

4. The water dispensing device of claim 3, further comprising:
a drainage path branched from the water outlet path between the water quality measurement unit and the water outlet port through which the raw water or the purified water is drained; and
a drainage pump disposed in the drainage path.

5. The water dispensing device of claim 4, wherein, when the water quality data measured by the water quality measurement unit corresponds to contamination level 2, the drainage pump is operated to discharge residual water into the drainage path.

6. The water dispensing device of claim 4, wherein, when the water quality data measured by the water quality measurement unit corresponds to contamination level 2, the water outlet sterilization module is operated.

7. The water dispensing device of claim 4, further comprising a water outlet valve selectively supplying the raw water or the purified water to the water outlet path and the drainage path.

8. The water dispensing device of claim 3, wherein, when the water quality data measured by the water quality measurement unit corresponds to contamination level 3, which is a contamination level higher than contamination level 2, the sterilization module is operated.

9. The water dispensing device of claim 8, wherein the purified-water path and the water outlet path are sterilized with high temperature water released from the sterilization module.

10. The water dispensing device of claim 8, wherein, when the water quality data measured by the water quality measurement unit corresponds to contamination level 3, the water outlet sterilization module is operated.

11. The water dispensing device of claim 8, wherein, when the water quality data measured by the water quality measurement unit corresponds to contamination level 4, which is a contamination level higher than contamination level 3, the sterilization module and the water outlet sterilization module operate together.

12. The water dispensing device of claim 11, wherein, when the water outlet sterilization module operates at contamination levels 3 and 4, the water outlet sterilization module emits ultraviolet rays for a longer period of time at contamination level 4 than at contamination level 3.

13. The water dispensing device of claim 1, wherein the water quality measurement unit re-measures the water quality of the purified water after passing the purified water therethrough at least once when the measured water quality data is higher than a contamination reference value.

14. The water dispensing device of claim 13, further comprising an output unit that displays water quality information when the measured water quality data is not higher than the contamination reference value.

15. The water dispensing device of claim 13, wherein the water quality measurement unit increases a waiting time until a next water quality measurement when performing the water quality re-measurement.

16. The water dispensing device of claim 1, further comprising a sensing path branched from the water supply path and through which the raw water flows,
wherein the water quality measurement unit measures the water quality of the purified water when the purified water enters through the purified-water path and measures the water quality of the raw water when the raw water enters through the sensing path.

17. The water dispensing device of claim 16, wherein the water quality measurement unit measures the water quality of the purified water after performing a rinse operation in which the purified water passes through at least once when measuring the water quality of the raw water.

18. The water dispensing device of claim 15, further comprising:
a switching valve for supplying the raw water to the water supply path or the sterilization path; and
a sensing valve for opening and closing the sensing path.

19. The water dispensing device of claim 1, wherein the water quality measurement unit comprises a turbidity sensor that emits light at the raw water or a portion of the purified water and senses turbidity based on a pattern of scattered light received.

20. The water dispensing device of claim 1, further comprising:
a hot water path branched from the purified-water path at one side;
a hot water module provided in the hot water path to heat purified water passing through the hot water path;
a cold water path branched from the purified-water path at one side; and
a cold water module provided in the cold water path to cool purified water passing through the cold water path.
